(19) United States
(12) Patent Application Publication
(10) Pub. No.: US 2017/0148002 A1
(43) Pub. Date: May 25, 2017

(54) KIOSK-BASED SYSTEMS AND METHODS FOR SELLING CONSUMER PRODUCTS AND/OR SERVICES

(71) Applicant: Outerwall Inc., Bellevue, WA (US)

(72) Inventors: Alexander Stock, New York, NY (US); Adam Rubin, Brooklyn, NY (US); Eric Chung, New York, NY (US); Theron Sarda, New York, NY (US); Jonathan Greenblatt, Brooklyn, NY (US); Kevin King, Sammamish, WA (US); Cord Frieden, Bellevue, WA (US); Tricia Montgomery, Bellevue, WA (US)

(21) Appl. No.: 14/948,005

(22) Filed: Nov. 20, 2015

(51) Int. Cl. G06Q 20/18; G06Q 20/42; G06Q 20/04; G06Q 30/02

(52) U.S. Cl. CPC G06Q 20/18; G06Q 30/0224; G06Q 30/0237; G06Q 20/42; G06Q 20/045

(57) ABSTRACT

Systems and methods are described herein for incentivizing consumers to recycle their accumulated change at consumer-operated coin counting kiosks. In various embodiments, the methods can include providing users with a plurality of deals on, e.g., leisure time activities and other rewarding goods and services that they can purchase at the coin counting kiosks in return for loose coins. The systems can include a software application, e.g., a mobile application that can be used to obtain user deal preferences and periodically provide users with deal offers that match their preferences and/or the amount of coin value they may have available to put toward a purchase. Other embodiments of the disclosed technology enable multiple users to purchase deals (e.g., group activities) as a group by making individual contributions toward the purchase price via a network of coin counting kiosks.

### TECHNICAL FIELD

The present disclosure relates generally to systems and methods for selling consumer products and/or services in return for coins and, more particularly, to systems and methods for incentivizing and facilitating efficient coin recycling via a network of consumer-operated coin counting kiosks.

### BACKGROUND

People often collect loose change in containers or drawers in their home or office. Once they have accumulated a sufficient quantity of coins, they can dispose of the coins in a number of different ways. For example, they can take their coins to a local bank, but some banks require that the coins be rolled and counted before they can be deposited or exchanged for cash. Other banks may charge a small fee for counting and depositing coins. Consumers can also exchange their coins for cash vouchers at a consumer-operated coin counting kiosk. Outerwall Inc., for example, operates a network of consumer-operated coin counting kiosks located in retail stores, banks and other publicly accessible areas. The kiosks count loose coins and dispense vouchers that can be redeemed for cash or merchandise if the kiosk is located in a store. Although there may be a service fee if the user elects to receive a cash voucher, many of kiosks also offer other products and services, such as e-certificates, gift cards, account transfers, etc. that usually do not have a fee.

Although consumer-operated coin counting kiosks provide an efficient way for consumers to recycle their coins, some consumers are hesitant to use such kiosks. This may be because none of the kiosk products appeal to these consumers and they do not want to pay the fee for a cash voucher, or because of the perception that simply receiving a cash voucher to use toward everyday purchases is not worth the effort of collecting up all their loose coins and taking them to a kiosk. Accordingly, it would be advantageous to provide new ways of encouraging consumers to use consumer-operated coin counting kiosks to recycle their loose coins.

### BRIEF DESCRIPTION OF THE DRAWINGS

FIG. 1 is a schematic diagram illustrating components of an environment for providing consumer products and/or services in exchange for coins, in accordance with an embodiment of the present technology.

FIG. 2 is a partially schematic isometric view of a consumer-operated coin counting kiosk configured in accordance with an embodiment of the present technology.

FIG. 3 is a block diagram illustrating components of a server computer configured in accordance with an embodiment of the present technology.

FIGS. 4A-4C illustrate a series of display pages for receiving user preferences and/or other user information in accordance with an embodiment of the present technology.

FIGS. 5A-5E illustrate a series of display pages for providing offer purchase information in accordance with an embodiment of the present technology.

FIG. 6A-6E illustrate a series of display pages for facilitating the purchase of offered products and/or services in accordance with an embodiment of the present technology.

FIG. 7 is a flow diagram of a routine for obtaining user preferences and/or other user information in accordance with an embodiment of the present technology.

FIG. 8 is a flow diagram of a routine for providing product and/or service purchase information in accordance with an embodiment of the present technology.

FIG. 9A is a flow diagram of a kiosk routine for facilitating the purchase of a consumer product and/or service in return for loose coins, and FIG. 9B is a flow diagram of an associated server routine for further facilitating the purchase, in accordance with an embodiment of the present technology.

FIG. 10A is a flow diagram of a kiosk routine for facilitating the purchase by one or more users of a consumer product and/or service in return for loose coins, and

FIG. 10B is a flow diagram of an associated server routine for further facilitating the purchase, in accordance with another embodiment of the present technology.

FIG. 11 is a flow diagram of a routine for determining a subset of purchase options to offer a user in accordance with an embodiment of the present technology.

### DETAILED DESCRIPTION

The following disclosure describes various embodiments of kiosk-based systems and methods for offering and selling discounted products, services and/or other things to consumers in return for loose coins. The products and services can include various types of fun activities and user experiences (e.g., athletic activities, social activities, fine dining, vacations, etc.), events that the user can attend (e.g., sporting events, concerts, etc.), consumer products (e.g., specialty products, luxury goods, etc.) and the like. In some embodiments, for example, the present technology includes a consumer application (e.g., a mobile application) that a user can download onto a mobile device (e.g., a smartphone) that notifies the user of various deals the user may be interested in purchasing. As used herein, the term “deal” generally refers to a discounted or otherwise attractive price for a product, service, experience, activity, etc., and can also be referred to as a “bargain.” The notification can be via an email, text message or other electronic communication to the user that is displayed on, for example, the user's mobile device. The deals presented to a particular user can be based on a number of factors, such as the user's purchase preferences, the estimated value of loose coins the user may have available to spend on such purchases, etc. When the user sees a deal he or she likes, the user can select the deal with the application, and then receive a unique code that will facilitate the user's purchase of the deal at an associated consumer-operated coin counting kiosk. The application may also provide the user with directions to the nearest coin-counting kiosk or one or more relatively close kiosks.

To purchase the deal, the user takes his or her coins to one of the coin counting kiosks, and inputs the unique code to bring up information about the deal on a kiosk display screen. Alternatively, the user can browse deals on the kiosk display screen to locate the selected deal or to find a new deal that the user may be interested in purchasing. Either way, the deal information can include, for example, the price of the deal, deal particulars (e.g., time or quantity constraints, etc.) the location of the corresponding merchant, and/or other details. The user can then deposit his or her coins in the kiosk to have them counted. If the total value of the coins falls short of the deal price, the user can provide additional funds at the kiosk in the way of cash, credit, etc. Alternatively, the kiosk can retain the coins as partial payment for the deal, and the user can return later with additional funds to complete the purchase. If the deal is being purchased by more than one user (for example, if the deal is for a group activity and others in the group wish to contribute toward the purchase price), then other users can visit a coin counting kiosk in their area, input the unique deal code (or otherwise locate identify the particular purchase) and input coins or other funds to apply toward the purchase. Once the user (or users) has provided full payment for the deal, the kiosk can provide the user with a voucher entitling the user to the associated product and/or service. Alternatively, the deal provider can send an email or other electronic communication or message to, e.g., the user's email address, phone number, web address, URL, mobile application, etc. that includes a purchase code, electronic voucher or the like that entitles the user to obtain the associated service or product. For example, if the deal is for an activity, such as rock climbing at a local gym, dining out, river rafting, etc., the user can present the paper voucher or the electronic equivalent to the local merchant or service provider at the time of use.

Many consumers may be unaware of the value of loose change they have accumulated at home. It is expected that embodiments of the present technology may motivate such users to recycle their accumulated coins by enabling them to spend the “phantom value” of these coins on special deals that they find more gratifying than a cash voucher for routine purchases. Providing the user with deals that are tailored to the user's particular preferences, combined with the excitement of getting a substantial discount or “bargain” on something the user may enjoy, can provide the added motivation and incentive for users to take their accumulated coins to a coin-counting kiosk for exchange.

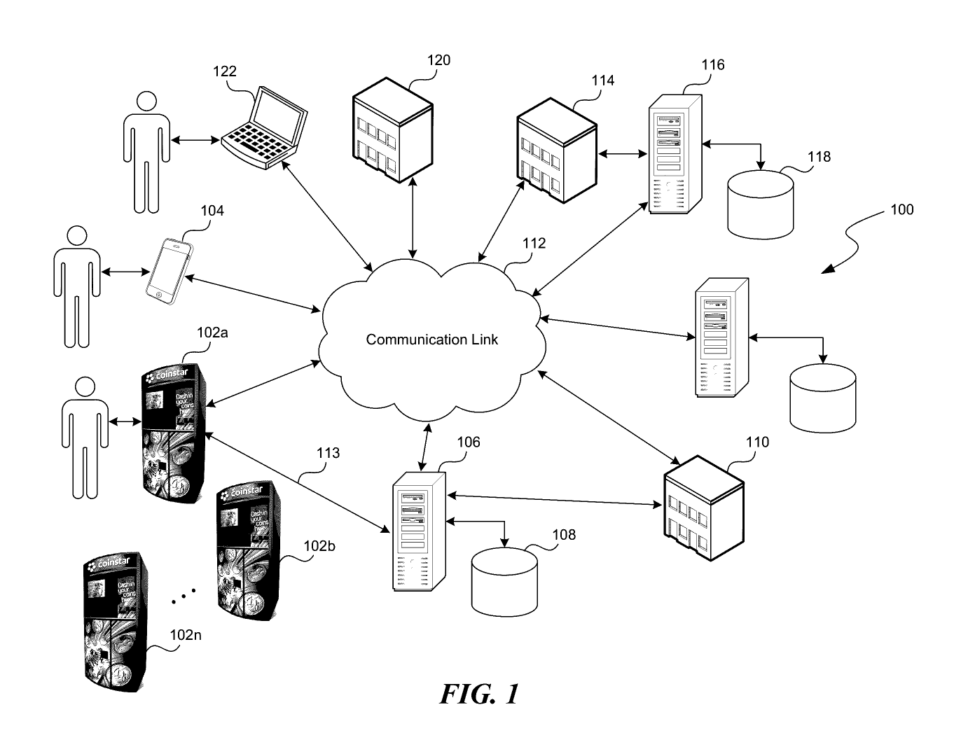

Certain details are set forth in the following description and in FIGS. 1-11 to provide a thorough understanding of various embodiments of the present technology. In other instances, well-known structures, materials, operations and/or systems often associated with consumer-operated kiosks, application software, mobile apps, processing devices and network systems are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention. Many of the details, dimensions, angles, arrangements and other features shown in the Figures are merely illustrative of particular embodiments of the technology. Accordingly, other embodiments can have other such features without departing from the spirit or scope of the present invention. In addition, those of ordinary skill in the art will appreciate that further embodiments of the invention can be practiced without several of the details described below.

In the Figures, identical reference numbers generally identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is a schematic diagram of a suitable computing environment 100 in which various embodiments of the present technology can be implemented. In the illustrated embodiment, the environment includes a plurality of consumer-operated coin counting kiosks 102 (identified individually as kiosks 102a-102n) that can be operably connected to one or more remote computers, such as a kiosk server computer 106 (“kiosk server 106”), via a communication link 112. The communication link 112 can include one or more wired or wireless networks such as, but not limited to, one or more of an intranet, the Internet, a Local Area Network (LAN), Wireless Local Area Network (WLAN), a Personal Area Network (PAN), Campus Area Network (CAN), a Metropolitan Area Network (MAN), a Wide Area Network (WAN), a Wireless Wide Area Network (WWAN), Global System for Mobile Communications (GSM), Bluetooth, Wi-Fi, LTE networks, and can use one or more messaging protocols such as, TCP/IP, SMS, MMS, extensible messaging and presence protocol (XMPP), real time messaging protocol (RTMP), instant messaging and presence protocol (IMPP), instant messaging, USSD, IRC, and/or any other wireless or wired data network or messaging protocols. Although the communication link 112 can include a publically available network (e.g., the Internet), the kiosks 102 can also connect to and communicate with the kiosk server 106 through a private communication link 113, such as an intranet or other wired or wireless communication network (e.g., a 3G or 4G network, antennae, integrated circuit, Wi-Fi chip, cable, etc.). Moreover, in various embodiments the individual kiosks 102 can be connected to a host computer (not shown) that facilitates the exchange of information between the kiosks 102 and remote computers, other kiosks, mobile devices, etc.

The kiosk server 106 can perform many or all of the functions for receiving, routing and storing electronic messages, such as webpages, audio signals and electronic images necessary to implement the various kiosk transactions described herein. For example, the kiosk server 106 can retrieve and exchange web pages and other content with an associated database or databases 108. In some embodiments, the database 108 can include information related to deal offers, kiosk operations, consumers, consumer accounts, etc. In various embodiments, the kiosk server 106 can include a server engine, a web page management component, a content management component, and a database management component. The server engine can perform the basic processing and operating system level tasks associated with various technologies described herein. The webpage management component can handle creation and/or display and/or routing of web or other display pages. The content management component can handle many of the functions associated with the routines described herein. The database management component can perform various storage, retrieval and query tasks associated with the database 108, and can store various information and data such as animation, graphics, visual and audio signals, etc. The kiosks 102 and the kiosk server 106 can be controlled and managed by a kiosk operator 110 that, among other things, can service the kiosks 102 to empty the kiosks of coins, replenish consumables, provide maintenance, etc.

In another aspect of the illustrated embodiment, the environment 100 includes a deal provider 114. The deal provider 114 can arrange and provide deal offers (for example, in the form of coupons) for consumers to purchase, e.g., activities, travel, goods and services from merchants (e.g., local merchants) at discounted prices. In some embodiments, Groupon, Inc. of Chicago, Ill. is one example of a deal provider. In other embodiments, other entities can arrange and provide deals, such as individual merchants, the kiosk operator, etc. The deal provider 114 can be operably connected to a deal server 116, the kiosks 102, and/or the kiosk server 106 via the communication link 112 and/or other wired or wireless communication links. The deal server 116 can perform many or all of the functions for receiving, routing and storing electronic messages, such as webpages, audio signals and electronic images necessary to implement the various deal transactions described herein. For example, the deal server 116 can retrieve and exchange web pages and other content with an associated database or databases 118. In some embodiments, the database 118 can include information related to deal offers (e.g., pricing, availability, timing, etc.), merchants, consumers, consumer accounts, and the like. For example, the database 118 can maintain data that associates consumers with their personal identification (e.g., username, password, etc.), deal preferences, deal selections, payment amounts, electronic contact information (e.g., email addresses, etc.), etc. In various embodiments, the deal server 116 can include a server engine, a web page management component, a content management component, and a database management component. In some embodiments, the environment 100 can also include a plurality of product and/or service providers 120 (e.g., local merchants) for providing information regarding products and services to the deal provider 114, the kiosk operator 110, and/or other components and entities in the environment 100.

In the illustrated embodiment, consumers may use various processing devices to receive information from, and exchange information with, one or more of the kiosks 102, the kiosk server 106, the deal server 116, and/or other communication, computing and processing devices in the environment 100. For example, in the illustrated embodiment users can receive deal information, deal notifications, etc., and input deal preferences, selections, etc., via a mobile device 104 (e.g., a smartphone), and/or a user computer 122 (e.g., a laptop, desktop, etc.). As those skilled in the relevant art will appreciate, the mobile device 104 can include various hand-held devices (including mobile phones, smartphones, personal digital assistants (PDAs), wearable computers, all manner of cellular or mobile phones, media players, gaming devices, etc.). Similarly, the user computer 122 can include various types of personal computers, including laptops, desktops, network PCs, mini-computers, mainframe computers, multi-processor systems, microprocessor-based or programmable consumer electronics, set boxes, etc. The mobile device 104 and the user computer 122 can each include a suitable display device, such as an LCD (liquid crystal display), or other suitable display screen for displaying information to the user, and a corresponding touch pad, touch screen, keyboard, pointing device (e.g., a mouse), or other suitable features for receiving user input, e.g., tactile selections. By way of example only, in the illustrated embodiment the mobile device 104 can include one or more features, applications and/or other elements commonly found in smartphones and other known mobile devices. For example, the mobile device 104 can include a CPU and/or a graphics processing unit (“GPU”) for executing computer readable instructions stored on memory. In addition, the mobile device 104 can include an internal power source or battery, a dock connector, a USB port, etc. In addition to the foregoing features, the mobile device 104 can include a mobile operating system (OS) and/or a device wireless transceiver that may include one or more antennas for wirelessly communicating with, for example, other mobile devices, websites, the deal server 116, the kiosk server 106, and/or the kiosk 102. Such communication can be performed via, e.g., the communication link 112, direct wireless communication, etc.

As those of ordinary skill in the art understand, the kiosks 102, the server computers 106 and 116, the mobile device 104, and the user computer 122 may include one or more central processing units or other logic-processing circuitry, memory, input devices, output devices (e.g., display devices), and storage devices. Such devices may include program modules such as an operating system, one or more application programs and the like. The user computers may include wireless computers, such as mobile phones, personal digital assistants (PDAs), palm-top computers, etc., which communicate with the Internet via a wireless link. The computers may be general-purpose devices that can be programmed to run various types of applications, or they may be single-purpose devices optimized or limited to a particular function or class of functions.

In the illustrated embodiment, the kiosks 102 and the kiosk server 106, and/or the deal server 116 can be operably connected to a plurality of remote devices and systems via the communication link 112. For example, the kiosks 102 and/or the servers 106 and 116 can be operably connected to a plurality of user devices (e.g., the mobile device 104 and other handheld devices, the user computer 122 and other personal computers, laptops, etc.) having associated browsers. Similarly, as described below the kiosks 102 can each include wireless communication facilities for exchanging digital information with mobile devices, such as the mobile device 104. As will be understood by those of ordinary skill in the art, the kiosks 102 and/or the servers 106 and 116 can also operably connect to various remote computers for obtaining data and/or exchanging information with service providers, financial institutions, merchants, manufacturers, authorities, government agencies, etc. necessary to implement portions of the disclosed technology. The financial institutions can include all manner of entity associated with conducting financial transactions, including banks, credit/debit card facilities, online commerce facilities, online payment systems, virtual cash systems, money transfer systems, etc.

The various components and component arrangements depicted in FIG. 1 are merely illustrative of an embodiment of the present technology. Unless described otherwise, the construction and operation of the various components shown in FIG. 1 are of conventional design. As a result, such components need not be described in further detail herein, as they will be readily understood by those skilled in the relevant art. Aspects of the invention may be practiced in a variety of other computing environments. Accordingly, other embodiments can include additional components. For example, those of ordinary skill in the art will understand that embodiments of the environment 100 can further include and/or be connectable to other entities, such as additional deal or coupon providers, financial institutions for reconciling purchases (e.g., banks, credit/debit card providers, accounting clearing houses), and/or other associated computer systems as necessary to implement electronic commerce and/or other aspects of the methods and systems described herein. Additionally, in other embodiments the environment 100 may lack one or more of the components shown in FIG. 1. Further, in some embodiments the various functions described herein with respect to one of the servers 106 and 116 can be performed by the other one of the servers 106 and 116. In other embodiments, the functions of both servers 106 and 116 may be combined in a single server, or divided among multiple other servers and/or other resources. Similarly, although the kiosk operator 110 and the deal provider 114 are depicted as separate entities in FIG. 1 for purposes of illustration, in other embodiments these two entities can be a single entity, and/or the various functions of each can be performed by other entities. For example, in other embodiments all or a portion of the functions performed by the deal server 116 can be performed by a server controlled by the kiosk operator 110.

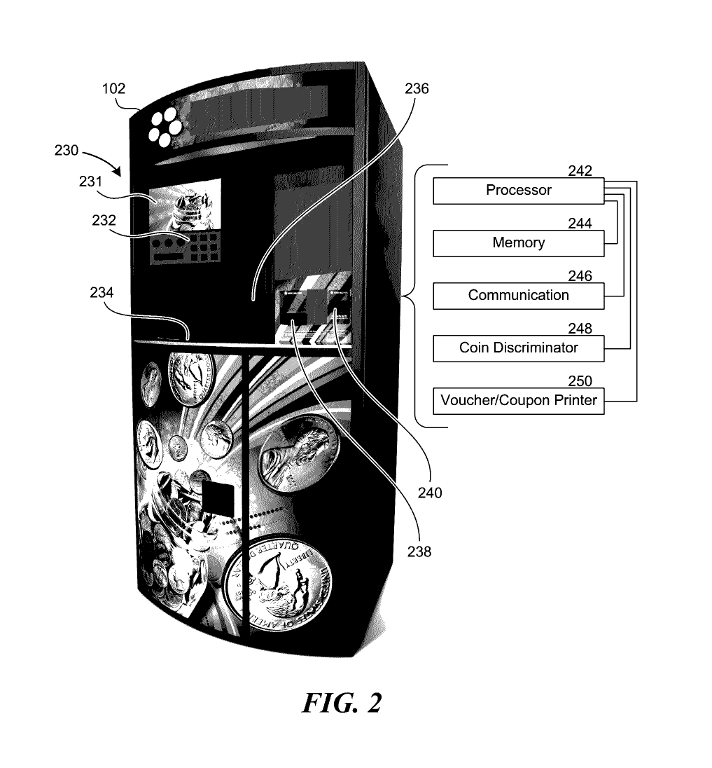

FIG. 2 is a partially schematic isometric view of one of the kiosk 102a-102n of FIG. 1 configured in accordance with an embodiment of the present technology. In some embodiments, the kiosks 102a-102n can be consumer-operated coin counting kiosks that are located in, for example, retail outlets (e.g., grocery stores, drug stores, etc.) banks, and/or other publically-accessible areas. Additionally, in some embodiments each of the kiosks 102 can be at least generally similar in structure and function to each other. In other embodiments, however, the kiosks 102 may differ from each other in various structural and/or functional ways.

In the illustrated embodiment, the kiosk 102 is at least approximately the same size as a conventional food or soft drink vending machine, and includes a user interface 230. The user interface 230 can include a display screen 231 and a keypad 232. The display screen 231 can present prompts and other textual and graphical information to users, and can include a touch screen or touch pad with which users can input information (e.g., user IDs, passwords, unique codes associated with deals, etc.) in response to the prompts displayed on the screen 231. The keypad 232 can include a plurality of tactile buttons that users can also use to input information in response to the prompts displayed on the screen 231.

The kiosk 102 includes a coin input region in which users can pour or otherwise place a plurality of loose coins for counting by the kiosk 102. In the illustrated embodiment, the coin input region 234 includes a hinged tray in which the user may pour their coins and then lift one side of the tray to cause the coins to flow into the kiosk 102. In other embodiments, other types of coin input devices and systems can be included with the kiosk 102. The kiosk 102 can house a coin discriminator 248 (shown schematically) for discriminating and counting the coins input by the user to determine a total value. The kiosk 102 additionally houses a voucher/coupon printer 250 (also shown schematically) for printing vouchers, coupons, receipts and/or other printed indicia associated with coin counting transactions that are dispensed to the user via a voucher/coupon outlet 236. In some embodiments, the user can supplement the coin value by providing additional funds to the kiosk. For example, the user can provide cash funds via a bill acceptor 240, and credit or debit value via a card reader 238 that can read, e.g., a magnetic stripe, optical indicia, etc. on a corresponding credit or debit card input by the user.

In addition to the foregoing features, the kiosk 102 can further include a central processor 242 (e.g., a CPU), memory 244 and a communication facility 246. The processor 242 can provide information and instructions to kiosk users via the display screen 231 and/or an associated audio system (e.g., a speaker; not shown). The processor 242 can also receive user inputs via, e.g., a touch screen associated with the display screen 231, the physical keys of the keypad 232, and/or a microphone. The processor 242 can control the operation of the various electronic and electromechanical components of the kiosk 102 in accordance with computer readable instructions stored on the memory 244. The processor 242 may be any logic processing unit, such as one or more CPUs, digital signal processors (DSPs), application-specific integrated circuits (ASICs), etc. The processor 242 may be a single processing unit or multiple processing units in a device or distributed across multiple devices. The processor 242 is connected to the memory 244 and may be coupled to other hardware devices, for example, with the use of a bus (e.g., a PCI Express or Serial ATA bus). The processor 242 can include, by way of example, a standard personal computer (“PC”) (e.g., a DELL OPTIPLEX 780 or 7010 PC) or other type of embedded computer running any suitable operating system, such as Linux, Windows, Android, iOS, MAC OS, or an embedded real-time operating system. In some embodiments, the processor 242 can be a small form factor PC with integrated hard disk drive (“HDD”) or solid-state drive (“SSD”) and universal serial bus (“USB”) or other ports to communicate with the other components of the kiosk 102. The memory 244 can include read-only memory (ROM) and random access memory (RAM) or other storage devices, such as disk drives or SSDs, that store the executable applications, test software, databases and other software required to, for example, implement the various routines described herein, control kiosk components, process information and data, communicate and exchange data and information with remote computers and other devices, etc.

The kiosk 102 can communicate with the various processing devices illustrated in FIG. 1 (e.g., remote servers, user devices, etc.) via the communication facility 246. The communication facility 246 can include a network connection (e.g., a wired connection, such as an Ethernet port, cable modem, FireWire cable, Lightning connector, USB port, etc.) and/or a wireless transceiver (e.g., including a Wi-Fi access point, Bluetooth transceiver, near-field communication (NFC) device, and/or wireless modem or cellular radio utilizing GSM, CDMA, 3G and/or 4G technologies) suitable for communication with, e.g., all manner of remote processing devices via, e.g., the communication link 112 and/or directly via, e.g., a wireless peer-to-peer connection. The kiosk 102 and/or various components and systems thereof can be at least generally similar in structure and function to the kiosks and corresponding kiosk components and systems described in the following U.S. patents and patent applications, each of which is incorporated herein in its entirety by reference: U.S. patent application Ser. Nos. 13/671,299, 13/367,129, 13/728,905, 13/790,674, 14/312,393, 14/617,672 and 14/674,860; and U.S. Pat. Nos. 5,564,546, 5,620,079, 6,056,104, 5,842,916, 6,116,402, 6,349,972, 8,033,375, 7,653,599, 7,865,432, 7,014,108, 9,064,268, 8,874,467, 8,967,361 and 9,022,841.

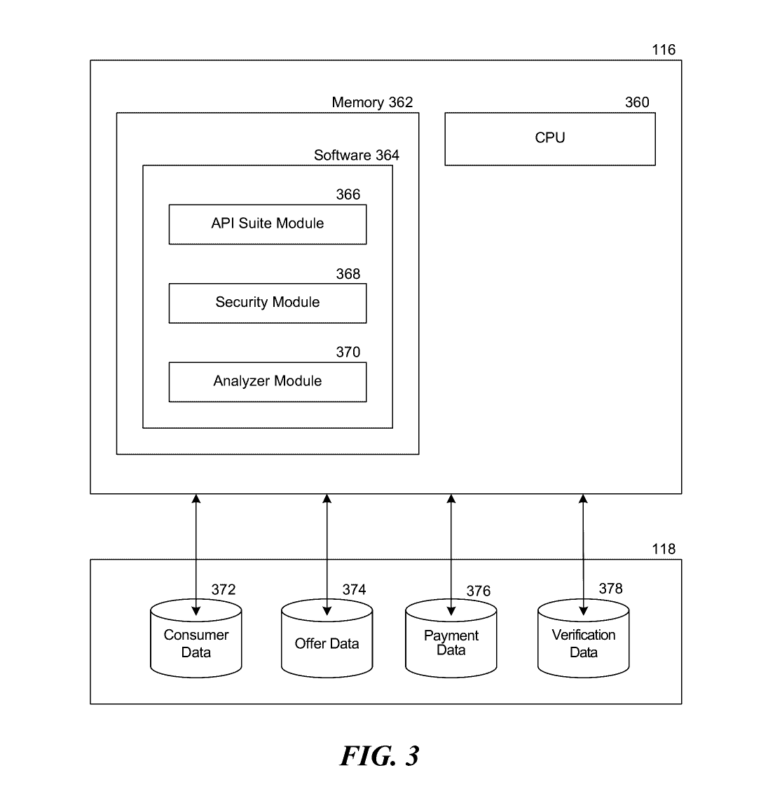

FIG. 3 is a block diagram illustrating a representative embodiment of the deal server 116 configured in accordance with an embodiment of the present technology. In the illustrated embodiment, the deal server 116 includes one or more central processing units (CPU) 360 for executing software 364 stored in memory 362. The software 364 can include one or more modules and data utilized by the modules. The modules can perform various functions and methods of the deal server 116 described herein and may also include components, subcomponents or other logical entities that assist with or enable the performance of some or all of these functions and methods. In the illustrated embodiment, the software 364 includes an API suite module 366 that provides a software-to-software interface that allows applications (e.g., mobile device applications, kiosk applications, etc.) and programs (e.g., kiosk software, mobile device software, and/or other software, etc.) to communicate with the deal server 116. The API suite module 366 can include one API or multiple APIs. For example, in some embodiments the API suite module 366 can include an API for accessing various deals on activities, goods and/or services, an API for accessing consumer information, an API for tracking and confirming purchase payments, an API for verifying consumer and/or deal information, etc. Accordingly, in some embodiments each API in the API suite module 366 can serve a different function. The APIs may exchange electronic communications back and forth between various applications for the deal server 116 and the other processing devices in the environment 100 of FIG. 1 (e.g., the kiosk server 106, the kiosk database 108, the kiosks 102, etc.), and these calls may be managed through Web services. Web services may include Extensible Markup Language (XML), which is one programming language by which applications can communicate over the Internet. In some embodiments, the API suite module 366 may use Simple Object Access Protocol (SOAP), which can encode XML messages so that they can be received and understood by multiple different operating systems over any type of network protocol. The API suite module 366 may also use Universal Description, Discovery, and Integration (UDDI) as an XML-based directory that allows businesses to list themselves, or it may use Web Services Description Language (WSDL).

The software 364 can also include a security module 368 that maintains secure and authentic communications between the deal server 116, the kiosks 102, the kiosk server 106, and/or other processing devices in the environment 100. In this regard, the security module 368 may comprise any combination of software agents and/or hardware components to filter such communications. The security module 368 can also implement other features. For example, if a user enters a unique deal code at one of the kiosks 102 and the kiosk transmits the code to the deal server 116, the security module 368 can communicate with the deal merchant and/or other resources to ensure that the code has not already been used and prevent the code from being duplicated for use more than once. Accordingly, in some embodiments the security module 368 can perform functions related to verifying a consumer's identity, verifying deal purchases, etc.

In another aspect of the illustrated embodiment, the representative software 364 can also include an analyzer module 370 that receives, reviews, and/or responds to queries and requests that may come from other modules or components of the environment 100. Additionally, in some embodiments the analyzer module 370 can process and analyze user information, such as user purchase preferences, user coin accumulation rates and other habits, user purchase histories, user notification requests, etc. Embodiments of the analyzer module 370 can include any combination of software agents and/or hardware components to perform such processes.

The deal server 116 can access the database 118 and/or other databases to perform all or a portion of the various routines described herein. As illustrated in FIG. 3, the database 118 can include, for example, consumer data 372, offer data 374, payment data 376, and verification data 378. The foregoing databases are accessible by and can exchange information and data with the modules described above, and the modules can in turn store information in the various databases or update the information in these databases continuously, periodically or sporadically. By way of example, the consumer data 372 can include various informational items such as consumer names, deal preferences, estimated coin saving rates, deal purchase history, alert and notification requests, etc. The offer data 374 can include information about the various deals being offered to consumers for purchase via the coin counting kiosk 102. For example, the offer data can include deal start and end dates, pricing, available quantities, etc. The payment data 376 can include information of purchase payment status. For example, the payment data can include confirmation of full purchase payments, running totals of partial payments for various deals, forms of payment, etc. The verification data 378 can include information necessary to verify, for example, consumer identities, deal parameters, payments, etc. For example, the verification data can include unique codes that correspond to particular deals that one or more users may have requested or reserved for purchase. The verification data 378 can also include user passwords, driver's license numbers, credit and debit card information, social security numbers, and/or other similar information for verifying the identity of users. As those of ordinary skill in the art will appreciate, the various components of the deal server 116 and the associated databases 372-378 described above are representative of server systems that can be configured in accordance with embodiments of the present technology. Accordingly, in other embodiments other types of server and database architectures can be employed to perform the various functions and methods described herein without departing from the present disclosure.

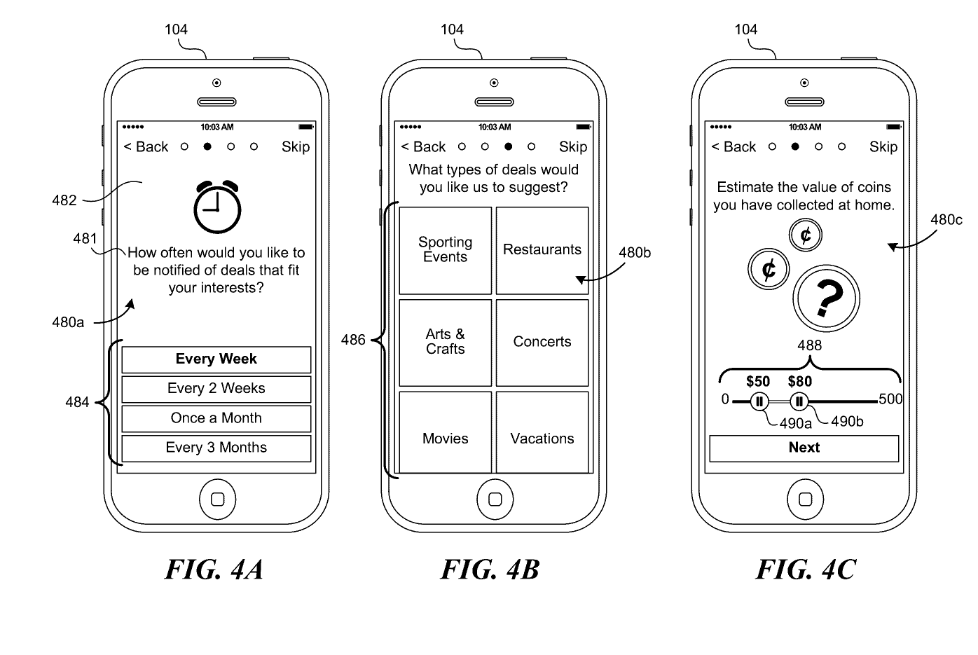

FIGS. 4A-4C illustrate a series of screenshots of display pages 480a-c that can be displayed by an application loaded onto a consumer's computing device to enable the user to take advantage of various deals that can be purchased with coins at one or more of the kiosks 102. In the illustrated embodiment, for example, the display pages 480a-c are displayed on a screen 482 of the mobile device 104 by a mobile application (“mobile app”) running on the device, and are configured to receive information from users regarding deal preferences and/or other user information. Referring first to FIG. 4A, the display page 480a presents a plurality of frequency buttons 484 (e.g., graphical control elements, icons, etc.), and a textual prompt 481 that asks the user how often he or she would like to be notified of deals that may fit the user's interest. The user can select a desired frequency by selecting (e.g., tapping or touching) the appropriate button 484. For example, in the illustrated embodiment the frequency buttons 484 enable the user to request deal notifications every week, every two weeks, once a month, every three months, etc. After the user has entered this information, the application sends the information to a remote computer, such as the deal server 116, to be associated with other user information such as user identification (username, password, etc.), email address or other electronic address, etc.

Turning next to FIG. 4B, the display page 480b includes a plurality of deal category buttons 486, and a textual query as to what types of deals the user would like to be notified about. In the illustrated embodiment, the deal categories include sporting events, arts and crafts, movies, restaurants, concerts and vacations. Sporting events can include, for example, discounted tickets to sporting events, as well as sporting activities that may be available to the user, such as rock climbing, river rafting, golf lessons, etc. The restaurant category can include discounted meal prices for one or more diners at various local restaurants. Although the foregoing deal categories relate to activities, in other embodiments the deal categories can also relate to goods, such as non-essential goods like fine foods and wine, jewelry, luxury items, etc.; services, such as spa treatments, massages, etc.; and/or other goods and services. Accordingly, the embodiments of the present technology are not limited to the various types of deals described herein, but can include virtually any type of activity, experience, good, service, etc. The user can select one or more of the activity categories by tapping the corresponding button 486. Doing so can send the category selection to the deal server 116 where it is associated with the user.

Turning next to FIG. 4C, the display page 480c includes a textual prompt asking the user to “estimate the value of coins you have collected at home,” and provides the user with a value selector 488 that enables the user to respond to the prompt. More specifically, in the illustrated embodiment the value selector 488 includes a first slider 490a and a second slider 490b which can slide back and forth on a horizontal bar from $0 to $500. Using a fingertip, the user can position the first slider 490a at a first location on the scale that represents the lower range of estimated coin value, and position the second slider 490b at a second location on the scale that corresponds to the upper estimate of estimated coin value. After the user responds to the various prompts on the display pages 480a-480c and inputs his or her preferences and other information, the information can be transmitted to the deal server 116 to be maintained in the database 118 and utilized by the server 116 to facilitate selecting various deal offers for the user, determining when to notify the user of such deals, and estimating the amount of coin value the user may have collected.

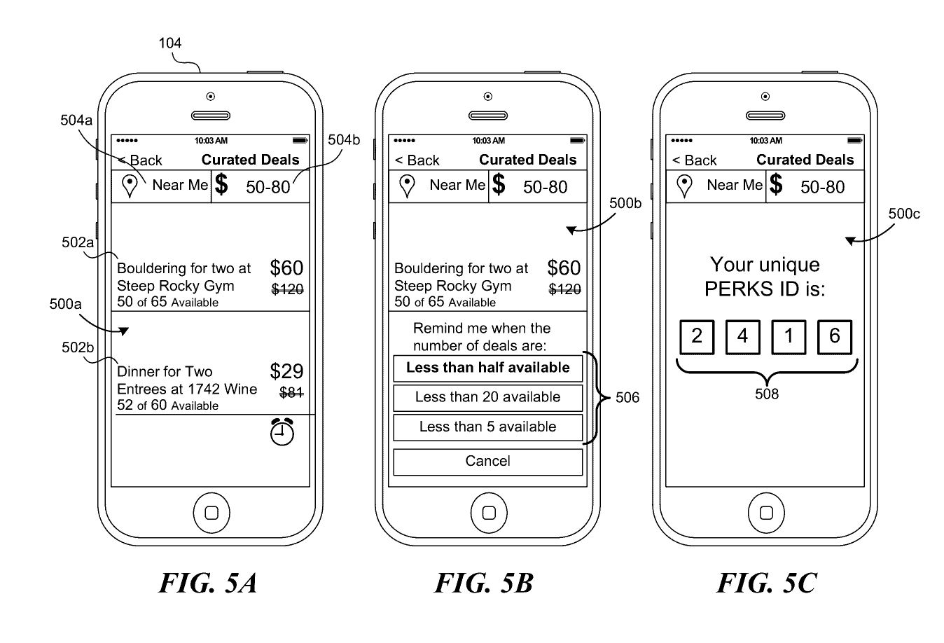

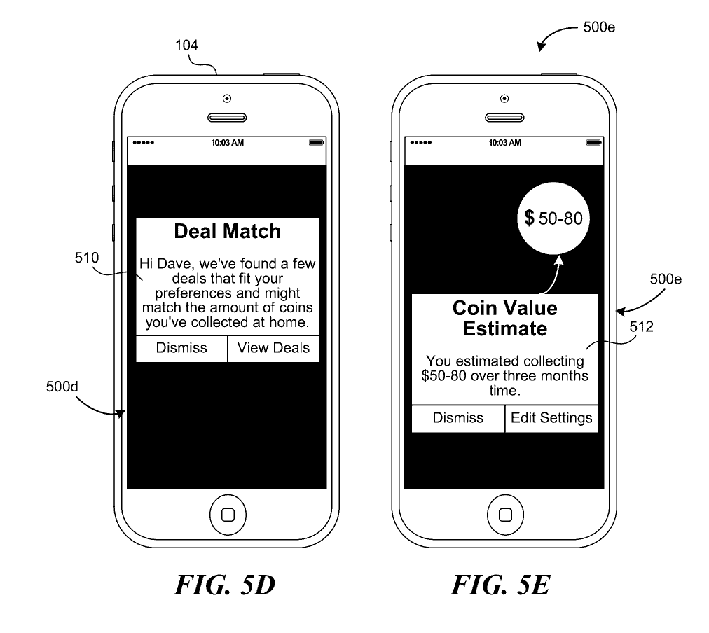

FIGS. 5A-5E illustrate a series of display pages 500a-500e that can be displayed on the mobile device 104 (or the user computer 122 or other user device) to notify users of deals, provide users with deal information, and perform other aspects of the present technology. Referring first to FIG. 5A, the display page 500a can be used to notify the user of deals that may be of interest to the user, may be near to the user, and/or may be in the user's price range. More specifically, in the illustrated embodiment the display page 500a includes a plurality of deal buttons 502, including a first deal button 502a (e.g., bouldering for two), and a second deal button 502b (e.g., dinner for two). The display page 500a can also include a proximity indicator 504a and a cost indicator 504b. In the illustrated embodiment, the proximity indicator 504a indicates that these deals are near the user, and the price indicator 504b indicates that the deals range in price from $50 to $80. If the user elects to purchase one of these deals, he or she can do so (e.g., “claim the deal”) by selecting the corresponding deal button 502a or 502b. As described in greater detail below, the deal selection can then be sent to the deal server 116, which can generate or otherwise provide a unique identification number or code, which in turn can be transmitted back to the user device 104 for display to the user and/or for storing in memory. As shown in FIG. 5C, for example, the display page 500c includes a code field 508 that provides the user with a unique deal code (e.g., “2416”). As described in greater detail below, the user can provide this code at one of the kiosks 102 to identify him or herself and/or to identify a deal offer that the user wishes to purchase. Inputting this code causes the kiosk 102 to display pertinent deal information so that the user can purchase the deal via the kiosk. In some embodiments, the user will have a limited amount of time (e.g., a number of days, such as three days) in which the user must visit a one of the coin kiosks 102 to exchange their coins and purchase the deal.

Referring next to FIG. 5B, the display page 500b enables the user to postpone making a decision on a particular deal. For example, the user may be interested in the bouldering activity (corresponding to the button 502a in FIG. 5A), but there may be only a limited number of bouldering deals available for purchase at the special price of $60. In this case, the user may wish to be reminded of this deal if the number of deals remaining drops below a certain level. To implement this feature, the display page 500b includes a plurality of quantity buttons 506 that enable the user to request a notification when the number of deals remaining drops to a selected level (e.g., when less than half of the deals remain available, less than 20 remain available, or less than 5 remain available). The user can select when he or she would like to receive the reminder by simply tapping the quantity button 506 corresponding to the desired number of deals remaining at the time of notification. After selecting a reminder criterion in this manner, the application on the mobile device 104 can send the reminder request to the deal server 116 for implementation.

In the illustrated embodiment, the deal server 116 can provide the user with various types of deal information at various times via the mobile application on the mobile device 104. For example, as shown in FIG. 5D the display page 500d notifies the user of deals that fit the user's preferences and might match the amount of coins the user has collected. More specifically, the display page 500d includes a deal alert 510 that gives the user the option of either viewing the details of the deals or dismissing the notification. If the user elects to view the deals, the application displays additional information about the deals, such as details about the corresponding activity, good or service, the quantity available, time limits, the price, the location, etc.

The deal server 116 can also provide the user with other deal information that may interest the user via the mobile application. For example, as illustrated in FIG. 5E, the display page 500e includes a notification 512 of an estimated coin value that the user may have accumulated over a period of time. For example, the user may have previously input information into the application estimating that he or she would collect between $50 and $80 in coins over a three-month period. This information can be sent to the deal server 116, which can then send a notification back to the application after three months have gone by to remind the user that he or she may have accumulated this much coin value, and to encourage the user to consider purchasing various deals with the coin value. In other embodiments, the deal server 116 can estimate a user's accumulated coin value based on, for example, how often the user uses the kiosk 102 and how much coin value is associated with each coin counting transaction. The deal server 116 can also estimate the user's accumulated coin value based on user preferences or other information, and periodically notify the user of this estimated coin value via the mobile application.

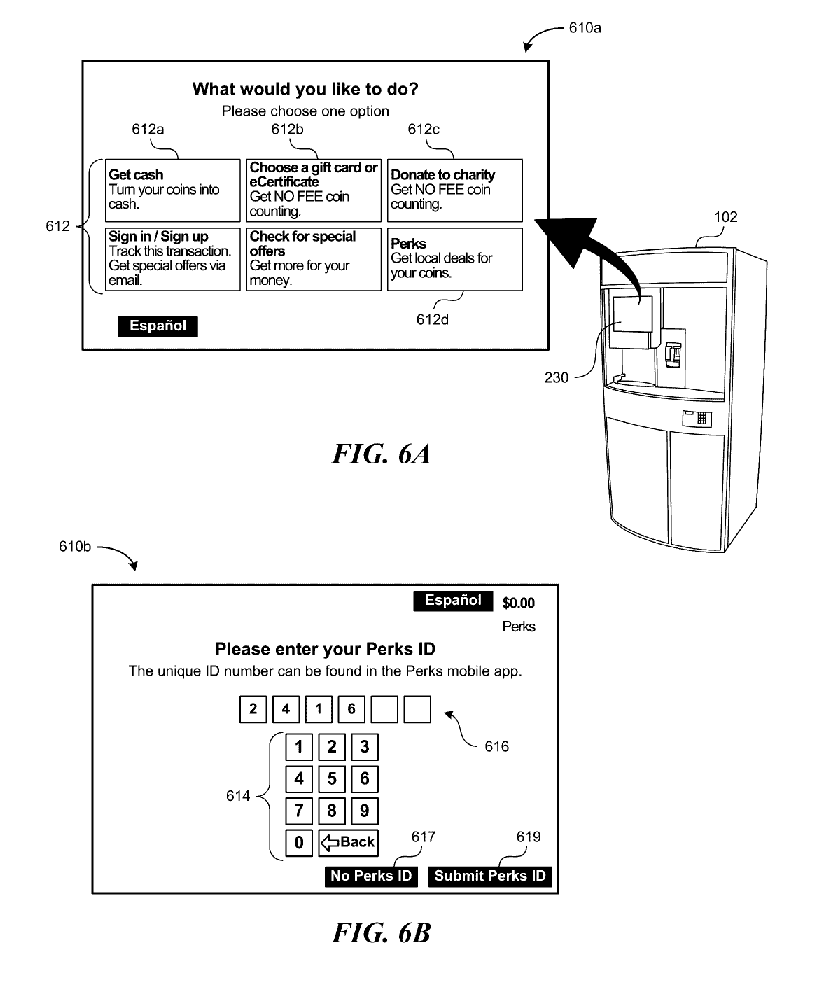

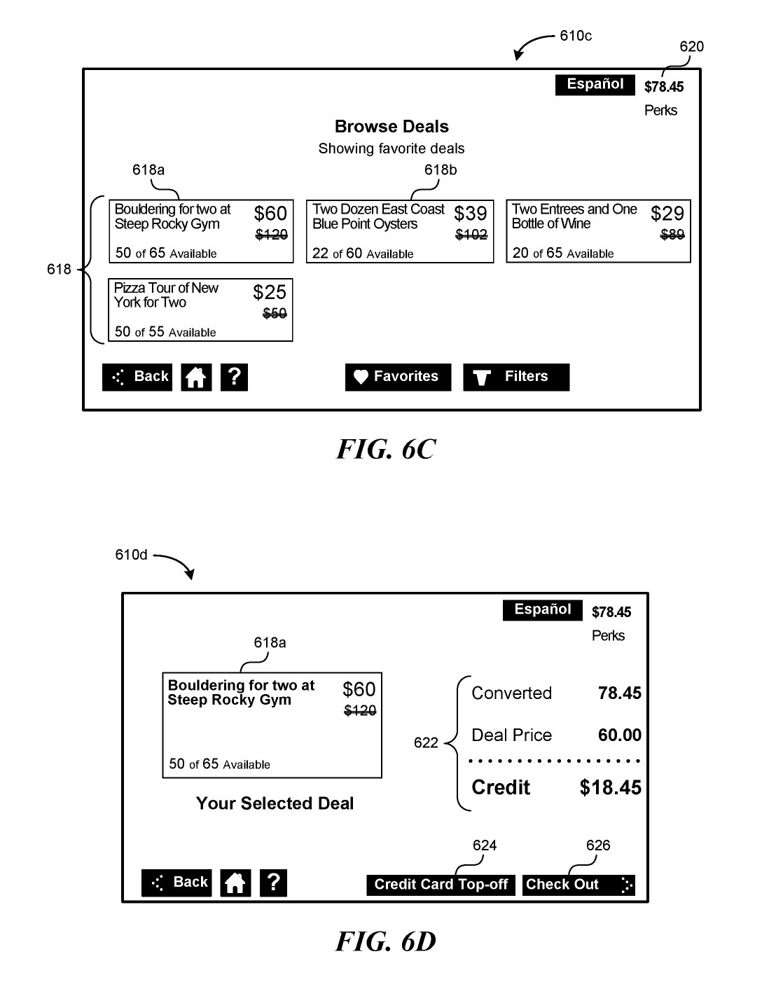

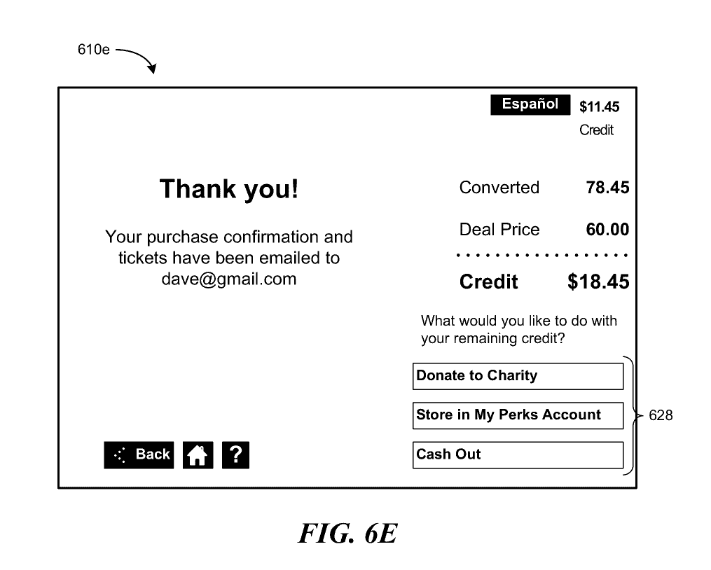

FIGS. 6A-6E illustrate a series of display pages 610a-610e that can be presented on the display screen 231 of the kiosk 102 to facilitate the purchase of deals in return for deposits of loose coins. The various display pages 610a-e can be provided by an application operating on the kiosk 102 in accordance with instructions executed by the processor 242. Referring first to FIG. 6A, the display page 610a may be displayed to the user when he or she first approaches the kiosk 102. In the illustrated embodiment, the display page 610a includes a touch screen having a plurality of option buttons 612 corresponding to various coin exchange transactions provided by the kiosk 102. For example, the options include enabling the user to obtain a cash voucher (612a), a gift card and/or an e-certificate (612b) in return for the user's coins. The user may also donate all or a portion of their coin value to charity (612c). Additionally, the display page 610a includes a deal button 612d. Selecting the deal button 612d enables the user to access a series of subsequent display pages for browsing available deals and/or making purchases.

In one embodiment, selecting the deal button 612d causes the kiosk 102 to present the display page 610b shown in FIG. 6B. The display page 610b includes a numeric touch pad 614 and a corresponding ID field 616. In some embodiments, users can have personal accounts for performing transactions (e.g., purchasing deals) with the kiosk system, and each account can be associated with a unique user ID or password. To access his or her account information, retrieve deal information, etc., the user can input his or her unique ID number into the ID field 616 via the touch pad 614. In addition or alternatively, in other embodiments the user can input a unique deal code into the field 616. The user can obtain a unique deal code in a number of different ways. For example, as described above with reference to FIGS. 5A-5C, the user can select one or more deals via the mobile application and, in response to selecting the one or more deals, receive a unique code that associates the one or more deals with the particular user, user ID, email address, etc. In other embodiments, the user can receive a unique deal code from various merchant websites that may post deal codes for particular deal offers, or by word of mouth from other users which form a group of individuals that are joining together to purchase the deal. Such group deals may involve activities or services that can be enjoyed by a group of people at the same time or individually. If the user has a unique deal code (e.g., “2416”), the user can input the code in the ID field 616 by sequentially depressing the corresponding numerical buttons in the touch pad 614. By submitting his or her unique code the user can access their account information and begin a transaction. Alternatively, if the user does not have a unique user ID or deal code but still wishes to browse available deals, the user may do so by selecting a no deal ID button 617.

After the user has input his or her unique ID or code, the kiosk 102 can respond by bringing up the display page 610c shown in FIG. 6C. The display page 610c presents a plurality of deal offers 618 that the user has saved (e.g., via the mobile application) as favorites. In the illustrated embodiment, the user's favorites include a first deal 618a for rock climbing at a local gym, and a second deal 618b for two dozen oysters at a local restaurant. At any time during the transaction, the user may deposit his or her coins in the coin input region 234 of the kiosk 102 (FIG. 2) and initiate the coin counting process to determine the total value of the coins (e.g., $78.45), which is displayed in a coin value field 620. This enables the user to compare the available deal prices to the amount of money he or she has available to spend at the time. If the user had not previously selected any favorite deals, the user is still able to browse various available deals, including deals within their price range by selecting the no deal ID button 617 in FIG. 6B, which will bring up a display page similar to display page 610c but with other or additional deal offers.

If the user selects, for example, the first deal offer 618a on the display page 610c, this brings up the display page 610d shown in FIG. 6D. The display page 610d provides transaction details including the selected deal offer 618a, and an accounting field 622 that shows the value of coins converted by the user, the deal price, and any remaining credit due the user. If, by way of example, the user's coin deposit was insufficient to cover the purchase price of the deal, the user can select a top off button 624 which enables the user to provide credit or debit card information (via the kiosk card reader 238 of FIG. 2) and/or cash (via the kiosk bill acceptor 240 of FIG. 2) to cover the price difference. The user can complete the purchase transaction by selecting a checkout button 626.

Referring next to FIG. 6E, after selecting the checkout button 626 of FIG. 6D, the kiosk application causes a purchase confirmation to be sent to the user. For example, as described above with reference to FIGS. 4A-4C, the user can enter his or her email address when they download the mobile application on the mobile device 104. When the user completes a deal at one of the kiosks 102, the kiosk 102 can send deal confirmation information to the deal server 116 (FIG. 1), which in turn sends a confirmation email to the user. The confirmation email can include various information confirming the deal purchase and entitling the user to obtain the purchased product or service, including, for example, a receipt, voucher, ticket, unique code, etc. As shown in FIG. 6E, the display page 610e also displays any credit remaining that is due to the user, and provides the user with a plurality of credit options 628. These options include donating the credit value to charity, storing the credit in the user's account for subsequent purchases, and/or applying the credit to a redeemable cash voucher, a gift card, an e-certificate or other form of remuneration. The user can select one or more of these options by tapping or touching the corresponding button.

The display pages of FIGS. 4A-6E may be implemented in any of various ways, such as in C++or as web pages in XML (Extensible Markup Language), HTML (HyperText Markup Language) or any other scripts or methods of creating displayable data, such as the Wireless Access Protocol (“WAP”). The screens or web pages provide facilities to present information and receive input data, such as a form or page with fields to be filled in, pull-down menus or entries allowing one or more of several options to be selected, buttons, sliders, hypertext links or other known user interface tools for receiving user input. While certain ways of displaying information to users is shown and described with respect to certain Figures, those skilled in the relevant art will recognize that various other alternatives may be employed. The terms “display page,” “screen,” “web page” and “page” are generally used interchangeably herein.

When implemented as web pages, the screens are stored as display descriptions, graphical user interfaces, or other methods of depicting information on a computer screen (e.g., commands, links, fonts, colors, layout, sizes and relative positions, and the like), where the layout and information or content to be displayed on the page is stored in a database typically connected to a server. In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), or matrix or bit-mapped formats. While aspects of the invention are described herein using a networked environment, some or all features may be implemented within a single-computer environment.

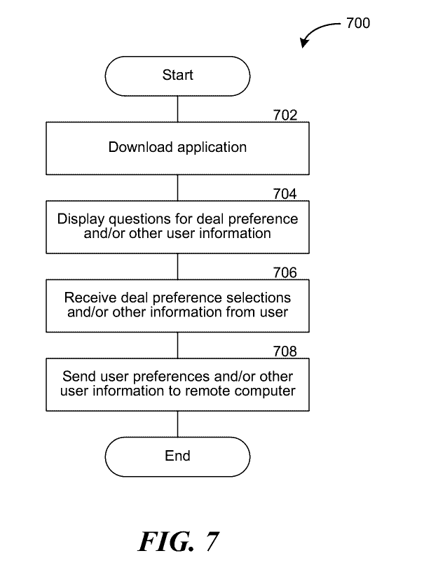

FIG. 7 is a flow diagram of a routine 700 for implementing an application on a user device (e.g. a mobile device, such as a smartphone) to obtain user preferences (e.g., purchase preferences, deal preferences, etc.) and/or other user information in accordance with an embodiment of the present technology. The routine 700 can be executed by a processing device, such as a processor or CPU associated with the mobile device 104 or the user computer 122 (FIG. 1) in accordance with computer-executable instructions stored on a computer-readable medium. For example, the routine 700 can be executed by application software running on the mobile device 104, the user computer 122, and/or other processing devices. In other embodiments, the routine 700 can be implemented by the kiosk 102 to collect user preferences and/or other user information. Those skilled in the relevant art will appreciate that aspects of the routine 700 can be practiced with other communications, data processing, or computer system configurations, including: Internet appliances, wearable computers, other hand-held devices, etc.

In block 702, the routine begins by downloading a consumer application (for example, by downloading the mobile app described above with reference to FIGS. 4A-4C from a remote computer, such as a web server, on the mobile device 104). In block 704, the routine displays one or more questions or instructions to prompt the user for deal preference and/or other user information. The display pages discussed above with reference to FIGS. 4A-4C include representative examples of such prompts, which can seek user input regarding desired timing for deal notifications, types of deals the user would prefer, the amount of coin value the user expects to spend on deals, the user's email address, etc. In block 706, the routine receives deal preference selections and/or other information from the user. As discussed above with reference to FIGS. 4A-4C, the routine can receive this information via icons, buttons, touch pads and/or other graphical control elements on associated display pages. In block 708, the routine sends the user preferences and/or other user information to a remote computer. For example, once the user has input his or her preferences into the application on the mobile device 104, the mobile device 104 can send the information to the deal server 116 via the communication link 112 (FIG. 1). As described in greater detail below, the deal server 116 can utilize this information to determine which deals to offer the user, the frequency of the offers, and/or other parameters of the deals offered to the user. After block 708, the routine ends.

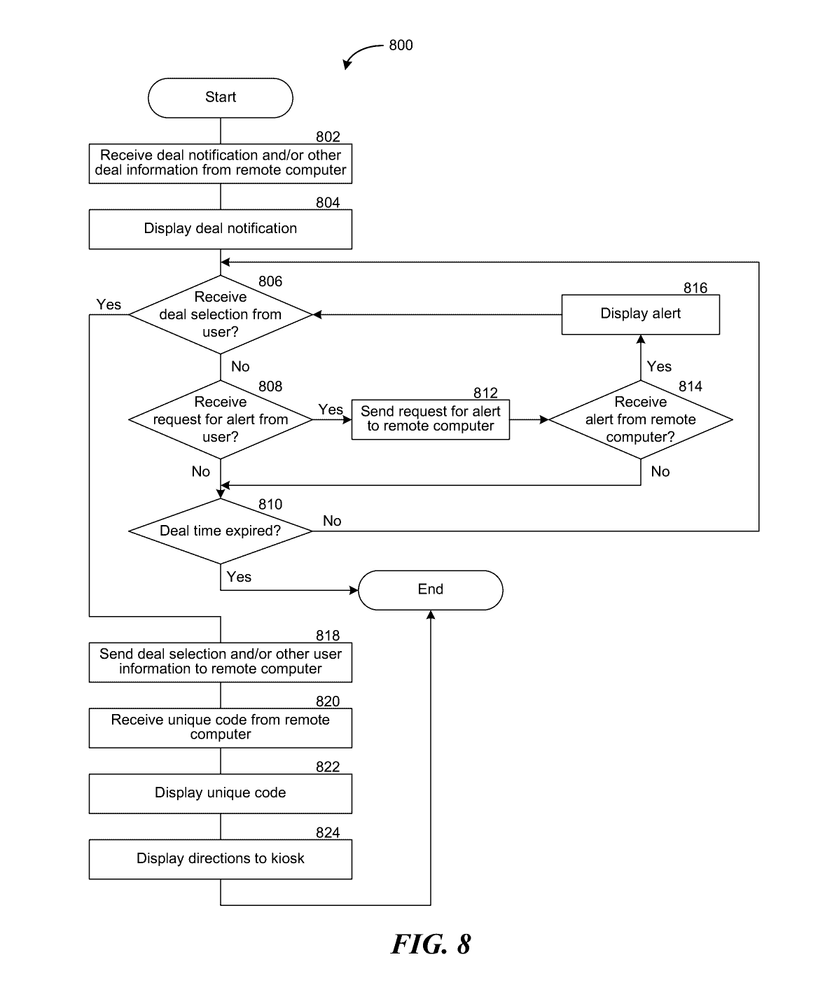

FIG. 8 is a flow diagram of a routine 800 that can be executed by an application (e.g., an application on the user's mobile device 104) to notify the user of deal offers and receive deal selections from the user in accordance with an embodiment of the present technology. In block 802, the routine receives notification of one or more deals and/or other deal information from a remote computer, such as the deal server 116 (FIG. 1). In block 804, the routine displays the deal notification and/or other deal information to the user. The display page 500a as described above with reference to FIG. 5A is one example of a way to display deal notification and other deal information to the user. In decision block 806, the routine checks to see if the user has selected one or more of the associated deals for purchase or possible purchase. By way of example, the user can select a deal for purchase by selecting the corresponding deal button 502a and/or 502b shown in FIG. 5A. If the routine does not receive a deal selection in decision block 806, the routine proceeds to decision block 808 to check whether the user has requested to be alerted or reminded about the deal at a later time, for example, when the quantity of deals remaining drops to a given number. As described above with reference to the display page 500b of FIG. 5B, the user can request such an alert by selecting the appropriate remaining quantity button 506 on the display page 500b. If the routine does not receive a request for a later alert, the routine proceeds to decision block 810 to determine whether the deal time is expired. For example, a particular deal offer may only be valid for a particular period of time or while a predetermined number of the deals last. If the deal time has expired, then the routine ends. If the deal time has not expired, the routine returns to decision block 806 and repeats.

Returning to decision block 808, if the routine does receive a request from the user for a later alert, the routine proceeds to block 812 and sends the request to a remote computer. For example, the routine can send the request for an alert to the deal server 116, which in turn can monitor the conditions of the alert and send an alert back to the user device if or when the conditions are met. In decision block 814, the routine checks to see if it has received an alert from the remote computer. If not, the routine proceeds to decision block 810 to determine if the deal time has expired. If the routine does receive an alert from the remote computer, the routine proceeds to block 816 and displays the alert for the user. Such an alert can be displayed on a user device (e.g., the mobile device 104, the user computer 122, etc.) by an application running on the device. After block 816, the routine returns to decision block 806 and repeats.

Returning to decision block 806, if after the routine displays the deal notification to the user the user selects one or more deals, then the routine proceeds to block 818 and sends the deal selections and/or other user information (e.g., user identification information, such as an email address, password, etc.) to a remote computer such as the deal server 116. In block 820, the routine receives a unique code back from the remote computer. In some embodiments, the unique code is associated with the selected one or more deals and the user identification information in a database, such as the database 118 (FIG. 1). In block 822, the routine displays the unique code for the user. As described above with reference to FIG. 5C, the display page 500c provides one example of a graphical display for communicating the unique code to the user. As shown in block 824, the routine can also display directions to the nearest kiosk so that the user can visit the kiosk and deposit his or her accumulated coins to complete the deal purchase transaction. The routine can determine the location of the nearest kiosk by providing the user's location (via, e.g., a GPS facility on the computing device) to the remote computer for comparison against kiosk locations. After block 824, the routine ends.

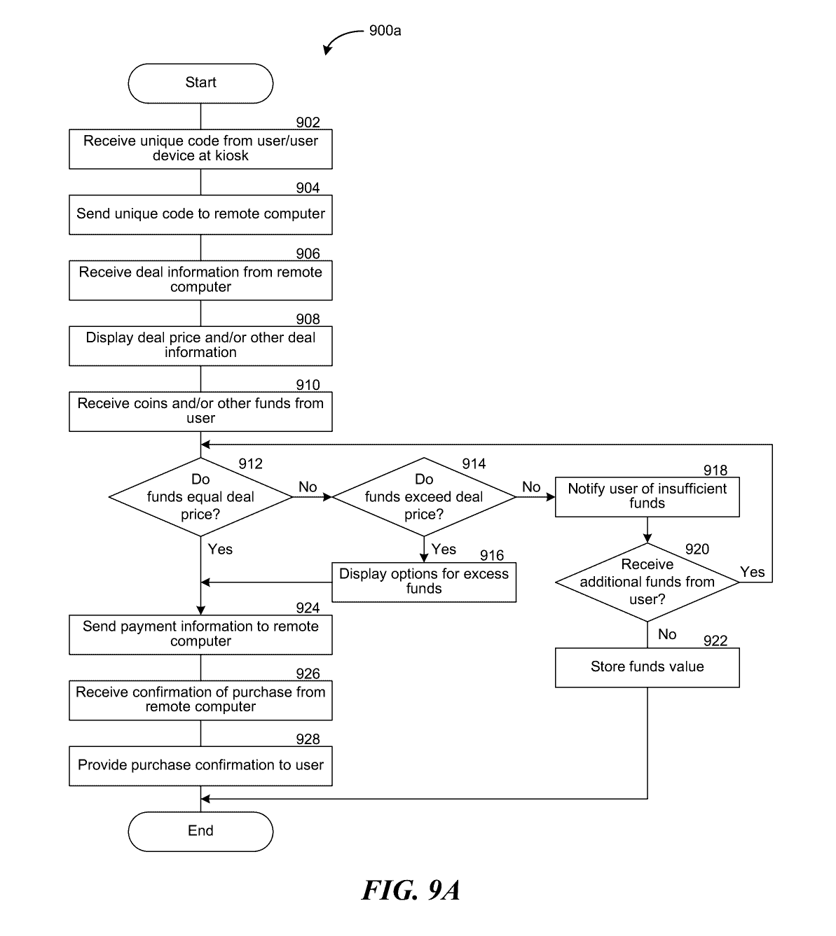

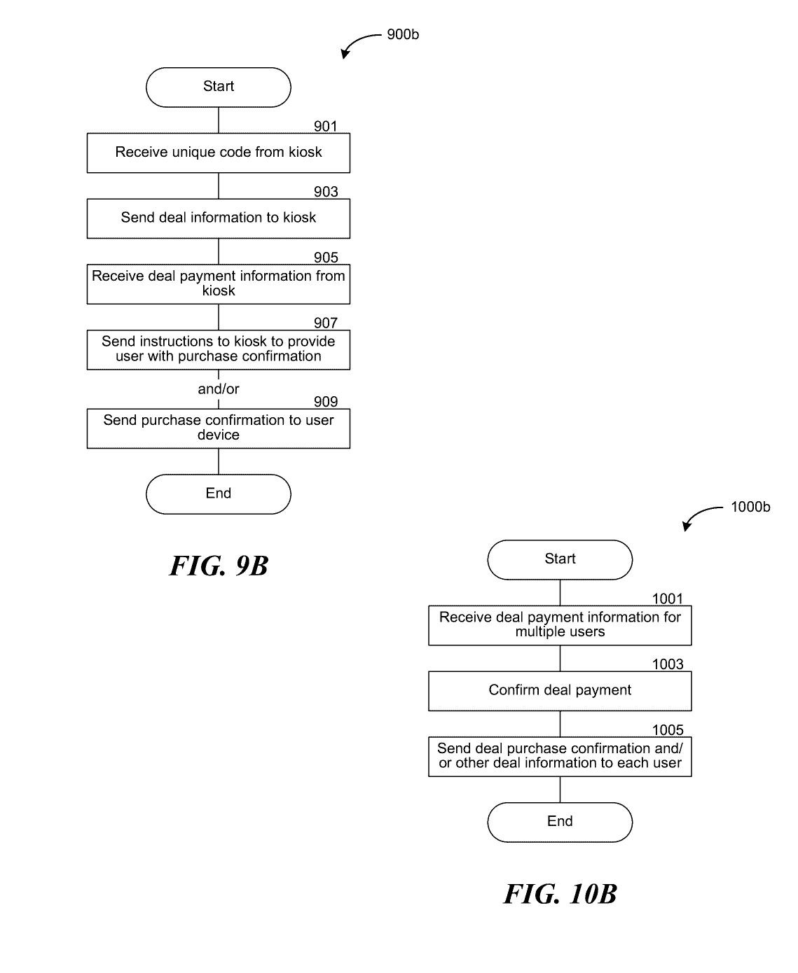

FIG. 9A is a flow diagram of a routine 900a for implementing a deal purchase transaction at the kiosk 102, and FIG. 9B is a flow diagram of a corresponding routine 900b for confirming the purchase transaction by the deal server 116 or other associated remote computer. Turning first to FIG. 9A, in one embodiment, the routine 900a can be executed by the kiosk processor 242 in accordance with computer-readable instructions stored on the memory 244. In block 902, the routine begins when the routine receives a unique code from a user at the kiosk 102. By way of example, the unique code can identify a user account, and/or the unique code may identify one or more deals that the user selected for purchase via a user device, such as a mobile application. For example, the routine can receive the unique code when the user approaches the kiosk 102 and enters the unique code via a user interface, such as the display page 610b of FIG. 6B displayed on the kiosk screen 231. In other embodiments, the user can wirelessly transmit the unique code to the kiosk 102 via a hand-held device, such as a smart phone, via near field communication (NFC) or other wireless communication technology. Similarly, in some embodiments the kiosk 102 can include a scanning facility to scan a QR code, barcode, mag stripe, or other optical or electronic indicia for providing the unique code to the kiosk 102. In block 904, after receiving the unique code from the user, the routine sends the unique code to a remote computer (e.g., the deal server 116). In block 906, the routine receives deal information from the remote computer in response to sending the unique code. The deal information can include, for example, deal price, applicable time limits or other restrictions, and/or other deal particulars. In block 908, the routine displays the deal price and/or other deal information for review by the user. In some embodiments, this information is displayed to the user via a display page, such as the display pages 610c and 610d of FIGS. 6C and 6D, respectively. Although the routine 900a starts with the user inputting a unique code at the kiosk 102, in other embodiments blocks 902 and 904 can be omitted, and the routine can begin by the user browsing available deals on the kiosk display screen 231 (see, e.g., the display page 610c of FIG. 6C) and selecting one or more deals to purchase. The kiosk 102 then sends the deal selections to the remote computer, which in turn provides information about the selected deals for display to the user as shown in blocks 906 and 908.

In block 910, the routine receives a plurality of randomly oriented loose coins from the user as payment for the selected deal. For example, the coins can be received in the coin input region 234 of the kiosk 102 and counted by the coin discriminator 248 (FIG. 2) to determine a coin value (e.g., a total coin value). In decision block 912, the routine determines if the total coin value is equal to the deal price. If not, the routine proceeds to decision block 914 to determine if the coin value exceeds the deal price. If the coin value does exceed the deal price, the routine proceeds to block 916 and displays various options for use of the excess funds. Such options can include, for example, donating the money to charity or saving the money in a user account for subsequent purchases. If the coin value does not exceed the deal price, then the routine proceeds to block 918 and notifies the user (via, e.g., the kiosk display screen 231) that the funds are insufficient to complete the purchase transaction. In decision block 920, the routine checks to see if the user has input additional funds. For example, in some embodiments the user can provide cash via the kiosk bill accepter 240 or use a credit or debit card to provide funds via the kiosk card reader 238 (FIG. 2). If the kiosk does not receive additional funds to cover the purchase, the routine proceeds to block 922 and stores the value of the funds received from the user in an account associated with the selected deal. This value can be tracked by the deal server 116 and/or the kiosk server 106 (and available for review by the user via the mobile application) as being applied toward the deal purchase price. If a period of time passes (e.g., five days, one week, etc.) without the user (or other users) contributing additional funds toward the purchase price, a reminder can be sent to the user to encourage them to deposit additional coins and complete the purchase. Additionally, in some embodiments the kiosk operator and/or the deal provider or merchant may elect to selectively award the user with the “top off” funds necessary to complete the purchase. After block 922 the routine ends.

Returning to decision block 920, if the user does input additional funds, then the routine returns to decision block 912. Once the kiosk 102 has received funds sufficient to cover the deal purchase price, the routine proceeds to block 924 and sends the payment information to the remote computer (e.g., the deal server 116). This information can include deal identification information as well as a confirmation that sufficient funds were received by the kiosk 102. In block 926, the routine receives confirmation of the purchase from the remote computer. In some embodiments, the confirmation can be an indication from the remote computer that the transaction has been completed and the kiosk should provide purchase confirmation to the user as shown in block 928. In some embodiments, the kiosk can provide purchase confirmation in the form of a printed voucher/coupon that includes written or other machine-readable indicia confirming the user's purchase of the deal and entitling the user to obtain the purchased activity, product, service, etc. In other embodiments, the purchase confirmation can be an electronic message (e.g., an email or text message) that includes similar information that enables the user to obtain the purchased deal from the associated merchant.

As discussed above with reference to FIG. 9A, in the illustrated embodiment the kiosk 102 receives a number of messages and other information from the remote computer (e.g., the deal server 116) as it is executing the routine 900a. The routine 900b of FIG. 9B is a representative example of the corresponding functions that can be executed by the remote computer in response to the messages received from the kiosk 102. For example, in block 901, the routine 900b begins when the remote computer receives the unique deal code from the kiosk 102 (or otherwise receives a request for deal information from the kiosk 102). In block 903, the remote computer retrieves information about the deal associated with the unique code (for example, from an associated database, such as the database 118 of FIG. 1), and sends the deal information back to the kiosk 102. In block 905, the routine receives deal payment information from the kiosk. As noted above, the deal payment information can include information from the kiosk 102 indicating that the user has provided the kiosk 102 with sufficient funds to purchase the deal. In block 907, the routine sends instructions back to the kiosk to provide the user with a purchase confirmation. In addition or alternatively, the remote computer can send the purchase confirmation to a user device (e.g., a smart phone, laptop, etc.) at the user's email address, phone number, etc. as shown in block 909. After block 909, the routine ends.

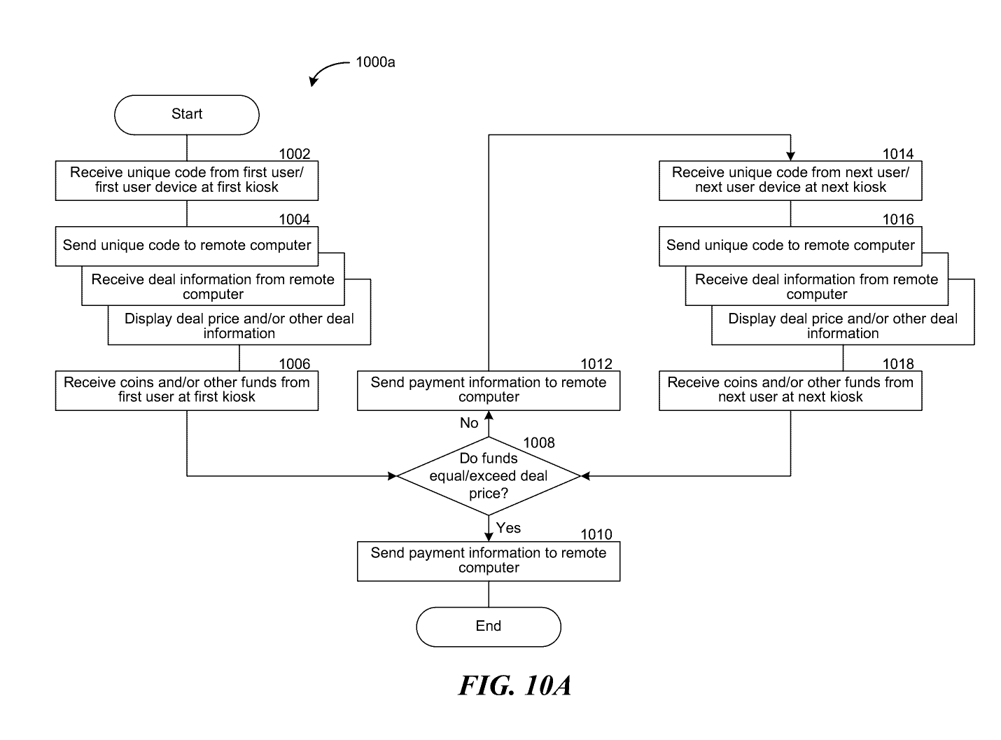

FIG. 10A is a flow diagram of a routine 1000a for implementing a deal purchase transaction at the kiosk 102 in accordance with another embodiment of the technology, and FIG. 10B is a flow diagram of a corresponding routine 1000b for confirming the purchase transaction by the deal server 116 or other associated remote computer. Many aspects of the routines 1000a and 1000b can be at least generally similar to the routines 900a and 900b described above with reference to FIGS. 9A and 9B, respectively. The routines shown in FIGS. 10A and 10B, however, enable multiple users to each contribute coin value toward the purchase of a deal via one or more of the kiosks 102. For example, a group of users may wish to all participate in a special activity, with each of the users contributing a portion of the funds toward the purchase price of the activity. Referring first to FIG. 10A, the routine begins when the routine receives a unique code and/or user ID from a first user (or first user device) at a first kiosk 102. As noted above with reference to FIG. 9A, the unique code or user ID can be associated with one or more deals the first user (or other user) has selected for purchase. In block 1004, the routine sends the unique code and/or user ID to a remote computer (e.g. the deal server 116). As discussed above with reference to FIG. 9A, after the kiosk has sent the code and/or ID to the remote computer, the kiosk 102 receives information from the remote computer about the associated deal. The information can include, for example, purchase price, time restrictions, and/or other deal details. The kiosk 102 then displays the deal price and/or other deal information for the user via, e.g., the kiosk display screen 231. In block 1006, the routine receives coins and/or other funds from the first user at the first kiosk as at least partial payment toward the deal purchase price. In decision block 1008, the routine determines if the coin value from the first user equal or exceed the deal price. If so, the routine proceeds to block 1010 and sends payment information to the remote computer. The payment information can include, among other things, information confirming that the kiosk 102 has received full payment from the first user. After block 1010, the routine can proceed as described above with reference FIG. 9A by receiving confirmation of the purchase from the remote computer, and then providing a purchase confirmation to the user, after which the routine ends.

Returning to decision block 1008, if the funds received from the first user do not equal or exceed the deal purchase price, the routine proceeds to block 1012 and sends payment information to the remote computer. The payment information can include the amount of the first user's partial payment toward the deal purchase price. This information can be stored in a database (e.g., the database 118), with the total amount paid being updated as other users (or the first user) make additional contributions toward the purchase price. For example, in block 1014 the routine receives the unique code and/or user ID from a second user (or second user device) at a second kiosk. In block 1016, the routine sends the code and/or ID to the remote computer and proceeds as described above until the second user inputs his or her coins in block 1018. After receiving the payment from the second user, the routine proceeds to decision block 1008 to determine if the combined funds from the first and second users equal or exceed the deal price. If not, the routine returns to block 1012 and repeats until enough funds have been collected from multiple users to purchase the selected deal. Once sufficient funds have been collected, the routine proceeds to block 1010 and sends the final payment information to the remote computer. After block 1010, the routine ends.

Turning next to FIG. 10B, as noted above the routine 1000b can be performed by the remote computer (e.g. the deal server 116) to facilitate purchase of a selected deal (e.g., a group activity) by multiple users at one or more of the kiosks 102. In block 1001, the server receives the deal payment information for multiple users. As noted above, this deal payment information can be sent to the remote computer from a plurality of kiosks 102 over a period of time as multiple users contribute coin value toward the deal price. In block 1003, the routine confirms that sufficient funds have been collected to purchase the deal. In block 1005 of the illustrated embodiment, the routine sends a deal purchase confirmation and/or other deal information to each user who contributed a portion of the payment for the deal. The routine can send the purchase confirmations via an email, text message, regular mail, etc. The purchase confirmation can be an electronic voucher or ticket that can be printed or displayed on, e.g., a mobile device to enable the user to obtain the deal (e.g., participate in the group activity) from the associated merchant. After block 1005, the routine ends.

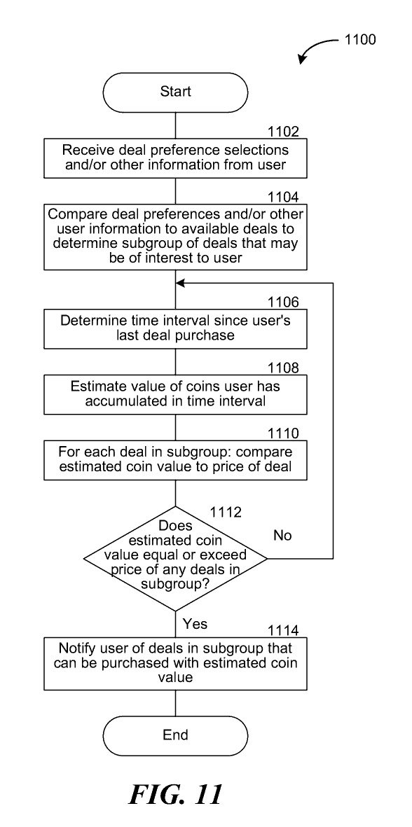

FIG. 11 is a flow diagram of a routine 1100 for selecting one or more deals to offer a user in accordance with an embodiment of the present technology. In some embodiments, the routine 1100 can be performed by a computer, e.g. a server computer that is remote from the kiosks 102, such as the deal server 116. In block 1102, the routine receives deal preference selections and/or other information from a user. As described above with reference to FIGS. 4A-4C, deal preference information can be received from users via an application (e.g. a mobile application) operating on the user's mobile device. The deal preference information can include the types of deals a user may be interested in (e.g., activities, consumer goods, services, etc.), deal price ranges, frequency of deal alerts, etc. This information can be stored in an associated database, such as the database 118. In block 1104, the routine compares the deal preferences and/or other user information to available deals to determine a subgroup of the available deals that may be of interest to the user. This comparison can include, for example, selecting deals from local merchants that match or approximate the user's preferred deal categories, price, etc. In block 1106, the routine can also determine the time interval since the user last purchased a deal via one of the kiosks 102, and in block 1008, the routine can estimate the value of coins that the user has accumulated in the intervening time period since the last purchase. In block 1110, the routine can compare the price of each deal in the subgroup or subset of deals to the estimated coin value. In decision block 1112, the routine determines if the estimated coin value is equal to or exceeds the price of any of the deals in the subgroup. If the estimated coin value does not equal or exceed the price of any of the deals the user may be interested in, then the routine returns to block 1106 and, after a preset period of time (e.g., one week, two weeks, etc.) repeats. Conversely, if the estimated coin value equals or exceeds the price of one or more of the deals, the routine proceeds to block 1114 and notifies the user of the deals that may be of interest to user and within his or her price range based on the estimated coin value. After block 1114, the routine ends.

FIGS. 7-11 are representative flow diagrams that depict processes used in some embodiments. These flow diagrams do not show all functions or exchanges of data, but instead they provide an understanding of commands and data exchanged under the system. Those skilled in the relevant art will recognize that some functions or exchange of commands and data may be repeated, varied, omitted, or supplemented, and other (less important) aspects not shown may be readily implemented. Each of the steps depicted in FIGS. 7-11 and the other flow diagram can itself include a sequence of operations that need not be described herein. Those or ordinary skill in the art can create source code, microcode, program logic arrays or otherwise implement the invention based on these flow diagrams and the detailed description provided herein.

The flow diagrams described herein are representative flow diagrams that depict routines and processes used in some embodiments. These processes and routines can be executed by a processing device, such as a processor or CPU associated with the kiosk 102, an associated server computer, wireless device, personal computer, etc. in accordance with computer-executable instructions stored on a computer-readable medium. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like, are generally used interchangeably herein and refer to any of the above devices and systems, as well as any data processor. These flow diagrams may not show all functions or exchanges of data, but instead they provide an understanding of commands and data exchanged under the system. Those skilled in the relevant art will recognize that some functions or exchange of commands and data may be repeated, varied, omitted, or supplemented, and other (less important) aspects not shown may be readily implemented. For example, while processes or blocks are presented in a given order, alternative implementations may perform routines having steps, or employ systems having blocks in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Various steps depicted in the flow diagrams can be of a type well known in the art and can itself include a sequence of operations that need not be described herein. Those of ordinary skill in the art can create source code, microcode, program logic arrays or otherwise implement the inventions described herein based on the Figures and the detailed description provided herein. The routines described above can be stored in non-volatile memory, or in removable media, such as disks, or hardwired or preprogrammed in chips, such as EEPROM semiconductor chips.

Those of ordinary skill in the art will appreciate that the routines and other functions and methods described herein can be implemented as an application specific integrated circuit (ASIC), by a digital signal processing (DSP) integrated circuit, through conventional programmed logic arrays or circuit elements. While many of the embodiments are shown and described as being implemented in hardware (e.g., one or more integrated circuits designed specifically for a task), such embodiments could equally be implemented in software and be performed by one or more processors. Such software can be stored on any suitable computer-readable medium, such as microcode stored in a semiconductor chip, on a computer-readable disk, or downloaded from a server and stored locally at a client.

At least one server computer, coupled to the Internet or World Wide Web (“Web”) or other network, performs much or all of the functions for receiving, routing and storing of electronic messages, such as web pages, audio signals and electronic images as described herein. The network may have a client-server architecture, in which a computer is dedicated to serving other client computers, or it may have other architectures such as a peer-to-peer, in which one or more computers serve simultaneously as servers and clients. A database or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL) password protection schemes, encryption, and the like).

The server computers described herein may include a server engine, a web page management component, a content management component, and a database management component. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data such as animation graphics and audio signals.

To provide for interaction with a user, embodiments of the subject matter described in this specification can be implemented on a computing device having an interface. An interface can be a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Also, devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

In general, the detailed description of embodiments of the described technology is not intended to be exhaustive or to limit the technology to the precise form disclosed above. While specific embodiments of, and examples for, the technology are described above for illustrative purposes, various equivalent modifications are possible within the scope of the described technology, as those skilled in the relevant art will recognize. For example, while processes, blocks, and/or components are presented in a given order, alternative embodiments may perform routines having steps, or employ systems having blocks, in a different order, and some processes or blocks may be deleted, moved, added, subdivided, combined, and/or modified. Each of these processes, blocks, and/or components may be implemented in a variety of different ways. Also, while processes, blocks, and/or components are at times shown as being performed in series, these processes, blocks, and/or components may instead be performed in parallel, or may be performed at different times.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/we claim:

1. A networked computer system configured to sell discounted products and services to consumers, the networked computer system comprising:
a processor; and
a memory storing instructions to be executed by the processor to:
receive purchase preferences from a user;
send an electronic notification of an offer for one or more discounted purchase options to an electronic device of the user, wherein the one or more purchase options are based on the purchase preferences;
receive a selection of at least one of the purchase options from the user;
receive confirmation of payment for the selected purchase option from a consumer-operated kiosk; and
in response to receiving the confirmation, instruct the consumer-operated kiosk to provide a confirmation of purchase to the user, wherein the confirmation of purchase enables the user to obtain a product and/or service associated with the selected purchase option.

2. The networked computer system of claim 1 wherein the selection is received from the user via the electronic device, and wherein the memory additionally stores instructions to be executed by the processor to:
in response to receiving the selection from the user, send a unique code to the electronic device for display to the user;
receive the unique code from the consumer-operated kiosk in response to the user inputting the unique code at the kiosk; and
in response to receiving the unique code from the consumer-operated kiosk, send the consumer-operated kiosk price information associated with the selected purchase option.

3. The networked computer system of claim 1 wherein the confirmation of payment for the selected purchase option confirms that the user has deposited a plurality of coins at the consumer-operated kiosk as payment in full for the associated product and/or service.

4. The networked computer system of claim 1:
wherein the confirmation of payment for the selected purchase option confirms that the user has deposited a plurality of coins at the kiosk as payment in full for the associated product and/or service, and
wherein the confirmation of purchase includes at least one of a voucher or coupon that is dispensed from the kiosk to the user, the voucher or coupon enabling the user to obtain the associated product and/or service without payment of additional funds.

5. The networked computer system of claim 1:
wherein the electronic notification of an offer is sent to the electronic device of the user via an email, text message, or notification for a mobile application,
and wherein the selection of at least one of the purchase options is received via an electronic message sent from the electronic device via the mobile application.

6. The networked computer system of claim 1, wherein the memory additionally stores instructions to be executed by the processor to:
select the one or more discounted purchase options by comparing the purchase preferences received from the user to a plurality of available discounted purchase options.

7. The networked computer system of claim 1, wherein the memory additionally stores instructions to be executed by the processor to:
select the one or more discounted purchase options by—
comparing the purchase preferences received from the user to a plurality of available discounted purchase options to determine a subgroup of discounted purchase options;
estimating a value of coins the user has accumulated since the user last made a purchase via the networked computer system; and
comparing the estimated value of coins to the prices of the purchase options in the subgroup of discounted purchase options to determine which of the purchase options in the subgroup can be purchased for the value of coins or less, wherein the one or more discounted purchased options includes the purchase options in the subgroup that can be purchased for the value of coins or less.

8. The networked computer system of claim 1:
wherein the user is a first user,
wherein receiving confirmation of payment for the selected purchase option includes receiving confirmation from a first kiosk of a first partial payment made by the first user, and receiving confirmation from a second kiosk of a second partial payment made by a second user, and
wherein instructing the consumer-operated kiosk to provide a confirmation of purchase includes instructing the first kiosk to provide a first confirmation of purchase to the first user, and instructing the second kiosk to provide a second confirmation of purchase to the second user, wherein the first confirmation of purchase enables the first user to obtain the associated product and/or service and the second confirmation of purchase enables the second user to obtain the associated product and/or service.

9. The networked computer system of claim 1:
wherein the user is a first user,
wherein the memory additionally stores instructions to be executed by the processor to send the electronic notification of the offer to an electronic device of a second user,
wherein receiving confirmation of payment for the selected purchase option includes receiving confirmation from a first kiosk of a first partial payment made by the first user, and receiving confirmation from a second kiosk of a second partial payment made by the second user, and
wherein instructing the consumer-operated kiosk to provide a confirmation of purchase includes instructing the first kiosk to provide a first confirmation of purchase to the first user, and instructing the second kiosk to provide a second confirmation of purchase to the second user, wherein the first confirmation of purchase enables the first user to obtain the associated product and/or service and the second confirmation of purchase enables the second user to obtain the associated product and/or service.

10. A computer-readable medium, excluding transitory signals, storing instructions that when executed by one or more processors cause a computer to implement a method for motivating users to exchange coins at one or more consumer-operated kiosks by:
estimating a value of coins a user has accumulated;
determining one or more products and/or services the user may be interested in purchasing;
comparing a discounted purchase price of the one or more products and/or services to the estimated value of coins; and
when the discounted purchase price is less than the estimated value of coins, sending an electronic notification to the user of the discounted purchase price and providing the user with instructions for purchasing the one or more products and/or services by depositing coins at one or more of the consumer-operated kiosks.

11. The computer-readable medium of claim 10 wherein the method further comprises:
determining when the user last deposited coins at one of the consumer-operated kiosks, wherein estimating the value of coins the user has accumulated includes estimating the value based on the interval of time since the user last deposited coins.

12. The computer-readable medium of claim 10 wherein the method further comprises:
determining when the user last deposited coins at one of the consumer-operated kiosks; and
determining the value of the coins the user last deposited, wherein estimating the value of coins the user has accumulated includes estimating the value based on the interval of time since the user last deposited coins and the value of coins the user last deposited.

13. The networked computer system of claim 1 wherein sending the electronic notification includes sending a first electronic notification, wherein there are a limited number of the one or more discounted purchase options available for purchase, and wherein the memory additionally stores instructions to be executed by the processor to:
send a second electronic notification of the offer to the electronic device of the user after a portion of the available discounted purchase options have been purchased by other users.

14. The networked computer system of claim 1 wherein sending the electronic notification includes sending a first electronic notification, wherein there are a limited number of the one or more discounted purchase options available for purchase, and wherein the memory additionally stores instructions to be executed by the processor to:
receive a request from the user for a second notification of the offer after a selected portion of the available discounted purchase options have been purchased by other users; and
send the second electronic notification of the offer to the electronic device of the user after the selected portion of the available discounted purchase options have been purchased by other users.

15. A network of coin counting kiosks including at least a first kiosk and a second kiosk remote from the first kiosk, at least the first kiosk comprising:
a user interface configured to receive information from a user;
a coin input region configured to receive a plurality of random coins from the user;
a coin discriminator configured to count the coins to determine a total value;
a communication facility configured to exchange electronic messages with one or remote computers;
a processor; and
a memory storing instructions to be executed by the processor to:
receive a unique code from the user via the user interface, wherein the unique code is associated with a discounted offer for a product and/or a service;
send the unique code to a remote computer via the communication facility;
in response to sending the unique code, receive purchase price information from the remote computer;
display the purchase price information to the user; and
receive coin information from the coin discriminator, wherein the coin information includes a total value of coins received from the user via the coin input region as at least partial payment for the discounted offer.

16. The network of coin counting kiosks of claim 15 wherein the total value of coins received from the user is full payment for the discounted offer, and wherein the memory additionally stores instructions to be executed by the processor to:
provide purchase confirmation to the user, wherein the purchase confirmation enables the user to obtain the product and/or service.

17. The network of coin counting kiosks of claim 15 wherein the user is a first user, wherein the coin information is first coin information including a first total value of coins received from the first user as a first partial payment for the discounted offer, and wherein the memory additionally stores instructions to be executed by the processor to:
receive the unique code from a second user via the user interface;
display the purchase price information to the second user; and
receive second coin information from the coin counter, wherein the second coin information includes a second total value of coins received from the second user via the coin input region as a second partial payment for the discounted offer.

18. The network of coin counting kiosks of claim 17 wherein a sum of the first and second partial payments is equal to or greater than full payment for the discounted offer, and wherein the memory additionally stores instructions to be executed by the processor to:
provide a purchase confirmation to the second user, wherein the purchase confirmation enables the second user to obtain the product and/or service.

19. The network of coin counting kiosks of claim 17 wherein a sum of the first and second partial payments is less than full payment for the discounted offer, and wherein the memory additionally stores instructions to be executed by the processor to:
send payment information to the remote computer, wherein the payment information causes the remote computer the send a notification to an electronic device of at least one of the first user, the second user, or a third user, the notification informing the recipient of the shortfall between the sum of the partial payments and full payment for the discounted offer.

20. The network of coin counting kiosks of claim 15 wherein the user is a first user, wherein the coin information is first coin information including a first total value of coins received from the first user as a first partial payment for the discounted offer, and wherein the second kiosk comprises:
a second user interface;
a second coin input region;
a second coin discriminator;
a second communication facility;
a second processor; and
a second memory storing instructions to be executed by the processor to:
receive the unique code from a second user;
display the purchase price information to the second user; and
receive second coin information from the second coin discriminator, wherein the second coin information includes a second total value of coins received from the second user via the second coin input region as a second partial payment for the discounted offer.

21. The network of coin counting kiosks of claim 20 wherein a sum of the first and second partial payments is equal to or greater than full payment for the discounted offer, and wherein the second memory additionally stores instructions to be executed by the second processor to:
provide a purchase confirmation to the second user, wherein the purchase confirmation enables the second user to obtain the product and/or service.

22. The network of coin counting kiosks of claim 21 wherein the product and/or service is a group activity, and wherein the purchase confirmation enables the first and second users to participate in the group activity.

23. The network of coin counting kiosks of claim 21 wherein the product and/or service is a consumer product, and wherein the purchase confirmation entitles the first and second users each obtain one of the consumer product.
